(19) United States
(12) Patent Application Publication
(10) Pub. No.: US 2007/0217111 A1
(43) Pub. Date: Sep. 20, 2007

(54) Surge Varistor Having Over-Temperature Protection

(76) Inventor: Ching-Lung Tseng, Miao-Li Hsien (TW)

Correspondence Address: Lin & Associates Intellectual Property, Inc., P. O. Box 2339, Saratoga, CA, 95070-0339, US

(21) Appl. No.: 11/426,938

(22) Filed: Jun. 28, 2006

(30) Foreign Application Priority Data
Mar. 3, 2006 (CN) 200610058396.0

(51) Int. Cl. H02H 9/06

(52) U.S. Cl. 361/118

(57) ABSTRACT

A surge varistor contains a varistor member and a disengagement member. The varistor member is parallel-connected to a load; while the disengagement member is series-connected to the load. The disengagement member is an elastic thin plate which contains a base portion and an elastically folded portion. The folded portion is soldered to a contact block extended from a terminal of the varistor member, thereby establishing a series connection between the varistor and disengagement members. When a surge to the load occurs, the varistor member enters shunts a large amount of current. If the temperature rises above a specific threshold, the soldering material binding the folded portion and the contact block is melted and the folded portion escapes from the contact block by its own elasticity, thereby breaking the electrical connection between the varistor and disengagement members.

### BACKGROUND OF THE INVENTION

1. Field of the Invention

The present invention generally relates to surge varistors, and more particularly to a surge varistor having a varistor member and a disengagement member for guarding against over-temperature.

2. The Prior Arts

Varistor derives its name by combining the words “variable resistor” together. Scientists had discovered long ago that ceramic dual-pole resistors made by high-temperature sintering ZnO powders have non-linear resistance-to-voltage relationship. Under a low voltage, the resistor has a very large resistance to prevent the conduction of electrical current while, under a high voltage, the resistance drops dramatically, allowing significant electrical current to pass through. It is therefore referred to as variable resistor, or varistor. The ZnO-based varistor is a type of metal oxide varistor (MOV). In addition to ZnO, SiC is also a common material for making varistors.

One typical application of the varistor is for surge protection. The working principle of the varistor in surge protection is as follows. Again, using the ZnO-based varistor as an example, it has been discovered that the non-linear behavior of the MOV would vary depending on the dopant doped in the ZnO powders. The typical current-to-voltage curve of a ZnO-based varistor can be divided into three regions: leakage region, non-ohmic region, and a large current region. When a ZnO-based varistor is arranged in a parallel connection with a load, the ZnO-based varistor would be operated in its leakage region under normal operation where the varistor has a very large resistance and the current in the circuit almost entirely flow through the load except that only a very small amount of leakage current would pass through the varistor. When a surge occurs resulted from a shock or a malfunction of the power supply that is greater than the breakdown voltage of the varistor, the varistor would enter its non-ohmic region where the resistance drops to only a few ohms to allow a very large amount of current to pass through, thereby protecting the load from being damaged by the surge.

When the large amount of current is shunted through the varistor, inevitably a large amount of heat is produced and such heat could destroy the varistor completely. U.S. Pat. No. 6,636,403 therefore teaches a varistor having a built-in fuse. The fuse contains a low temperature solder fillet and is surrounded by hot melt electrically insulating material. Under over-voltage conditions, the link and the solder fillet melt, and an insulating gap is rapidly created.

### SUMMARY OF THE INVENTION

An improved surge varistor is provided herein which offers more reliable over-temperature and over-voltage protection.

The present invention contains a varistor member and a disengagement member series-connected together. The surge varistor provides three terminals. A first terminal is from an end of the varistor member; a third terminal is from an end of the disengagement member; and a second terminal is from the junction point of the other terminals of the varistor member and the disengagement member. The second and first terminals are parallel-connected to a load; while the third and second terminals are series-connected to the load. The disengagement member is an elastic thin plate which contains a base portion and an elastically folded portion. The folded portion is soldered to a contact block extended from the second terminal, thereby establishing an electrical connection from the third terminal to the second terminal via the thin plate. Under normal operation, a voltage is applied to the load via the third terminal, the disengagement member, and the terminal 2 as the varistor member 20 operates in the leakage region and presents a very large resistance to the voltage. When a surge occurs, the varistor member enters the non-ohmic region and shunts a large amount of current through the third terminal, the disengagement member, and the first terminal. If the temperature rises above a specific threshold, the soldering material is melted and the folded portion escapes from the contact block by its own elasticity, thereby breaking the electrical connection between the third and second terminals.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the application of the surge varistors according to the present invention between the live wire, neutral wire, and ground wire of an AC power source.

FIG. 2A is perspective exploded view showing a surge varistor according to an embodiment of the present invention.

FIG. 2B is a perspective view showing the surge varistor of FIG. 2A when its terminals 2 and 3 are electrically connected.

FIG. 2C is a perspective view showing the surge varistor of FIG. 2A when its terminals 2 and 3 are disengaged.

FIG. 3A is perspective exploded view showing a surge varistor according to another embodiment of the present invention.

FIG. 3B is a sectional view showing the surge varistor of FIG. 3A when its terminals 2 and 3 are electrically connected.

FIG. 3C is a sectional view showing the surge varistor of FIG. 3A when its terminals 2 and 3 are disengaged.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

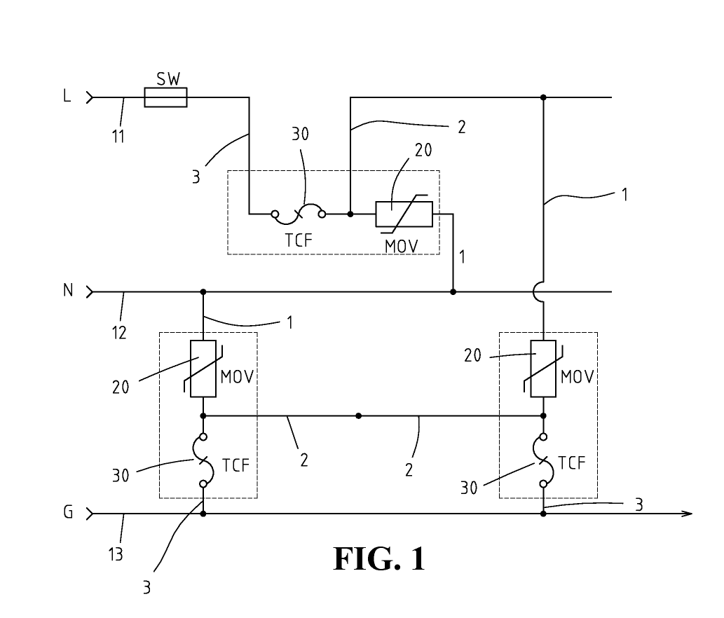

FIG. 1 is a schematic diagram showing the application of the surge varistors according to the present invention between the live wire 11, neutral wire 12, and ground wire 13 of the live terminal (L), neutral terminal (N), and ground terminal (G) of an AC power source. As illustrated, the surge varistor contains a varistor member 20 and a disengagement member 30 (marked as TCF), each of which has two terminals. The varistor member 20 and the disengagement member 30 are series-connected together. The surge varistor provides three terminals. The terminal 1 is from an end of the varistor member 20; the terminal 3 is from an end of the disengagement member; and the terminal 2 is from the junction point of the other ends of the varistor member 20 and the disengagement member 30.

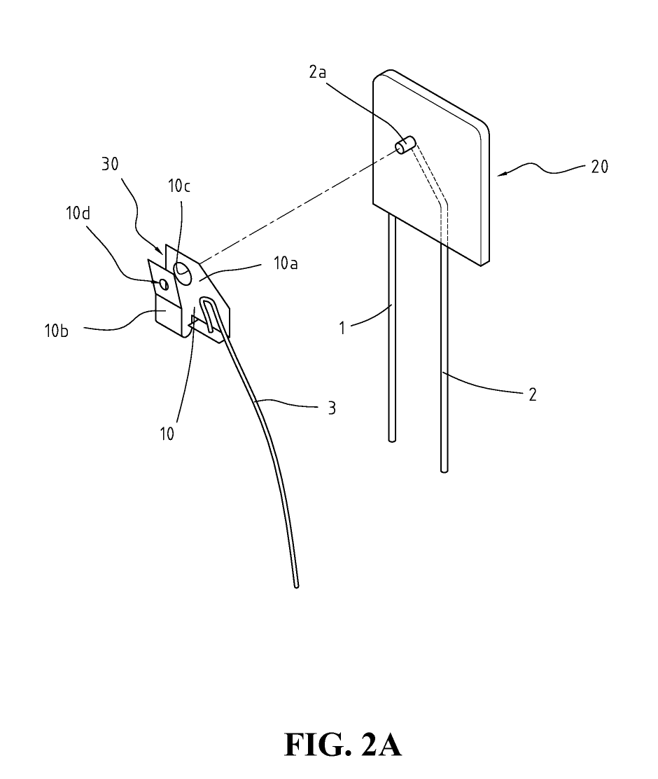

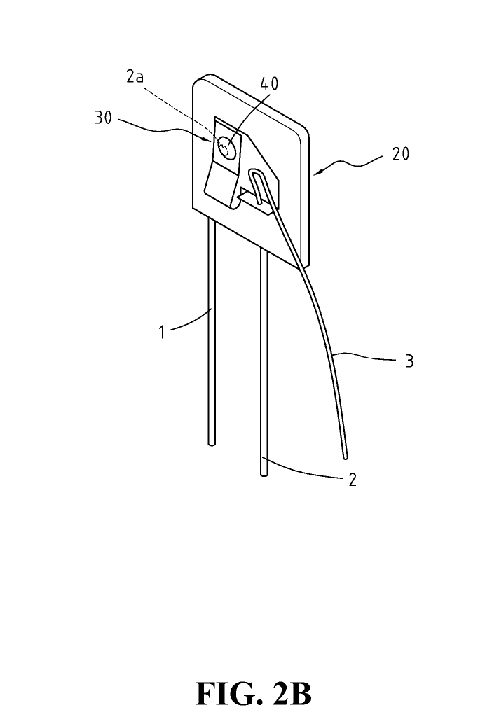

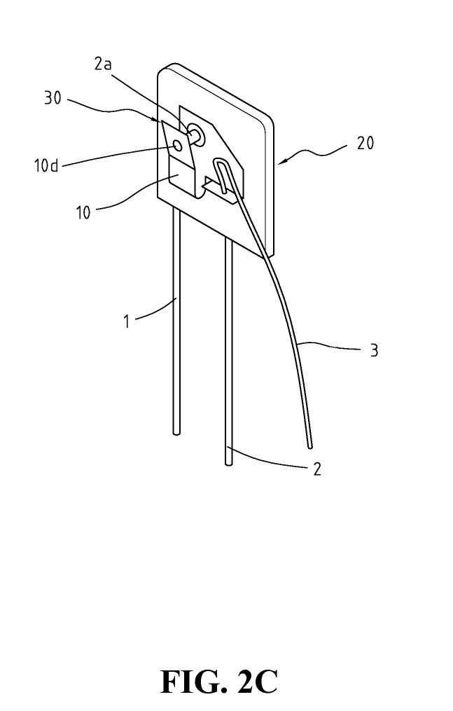

FIG. 2A is a perspective exploded view showing a surge varistor according to an embodiment of the present invention. As illustrated, the terminals 1 and 2 of the surge varistor are the two terminals of the varistor member 20. The body of the varistor member 20 is coated with a layer of insulating material (not shown). An electrically and thermally conducting contact block 2a is extended from the end of the terminal 2 buried inside the body of the varistor member 20 for an appropriate distance out of the body of the varistor member 20. The disengagement member 30 basically is an electrically and thermally conducting thin plate 10 having a base portion 10a coupled to the terminal 3 of the surge varistor. The plate 10 has a first through opening 10c within the base portion 10a whose aperture is larger than the diameter of the contact block 2a so that, when the base portion 10a is flatly adhered to the body of the varistor 20, the contact block 2a is exposed through the first through opening 10c without contacting each other. An elastic strip 10b is extended from the base portion 10a and folded over to cover the first through opening 10c and the contact block 2a. The strip 10b has a second through opening 10d at an appropriate location so that, when the strip lob is folded towards the contact block 2a, the contact block 2a can be threaded through the second through opening 10d.

As illustrated in FIG. 2B, the folded strip 10b and the contact block 2a exposing through the second through opening 10d are soldered together by an electrically and thermally conducting material 40. As such, an electrical connection is established from the terminal 2 to the terminal 3 via the plate 10 (i.e., the disengagement member 30). Without the binding of the material 40, as shown in FIG. 2C, the elasticity of the strip 10b would cause the strip 10b to break away from the contact block 2a and the base portion 10a, disrupting the electrical connection between terminals 2 and 3. Please refer to FIG. 1 again. Using the surge varistor at the top of drawing as an example, the voltage provided by live wire 11 would be conducted through the terminal 3, the disengagement member 30 (i.e., the plate 10), and the terminal 2, to a load (not shown) under normal circumstance as the varistor member 20 operates in the leakage region and presents a very large resistance to the voltage. When a surge on the live wire 11 occurs, the varistor member 20 enters the non-ohmic region and shunts a large amount of current through the terminal 3, the disengagement member 30, and the terminal 1, into the neutral wire 12. If the temperature continues to rise up to a specific threshold, the material 40 is melted and the strip lob escapes from the contact block 2a by its own elasticity, thereby breaking the electrical connection between the terminals 2 and 3. As such, the circuit and the varistor member 20 are protected from the high-temperature hazardous condition.

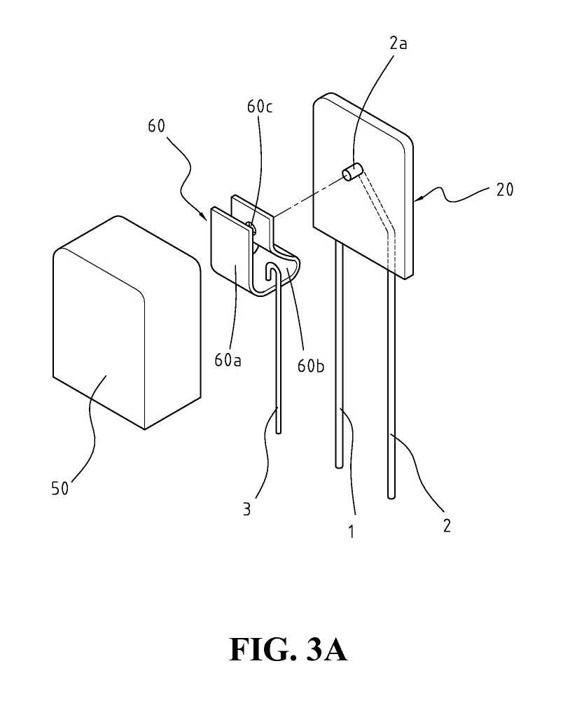

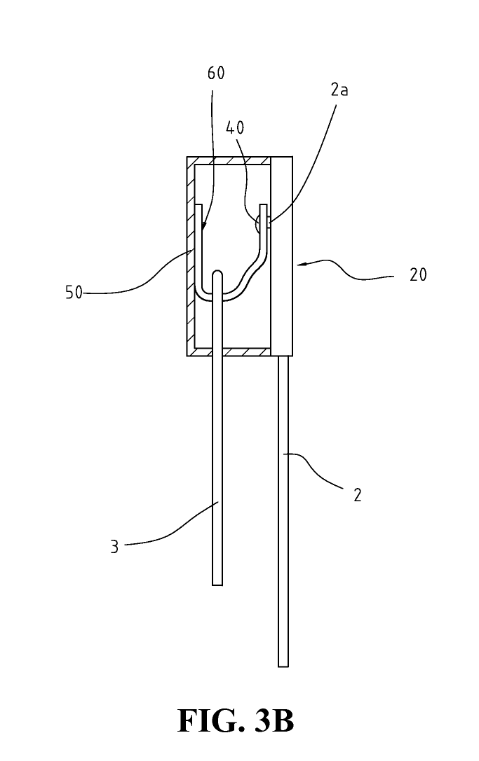

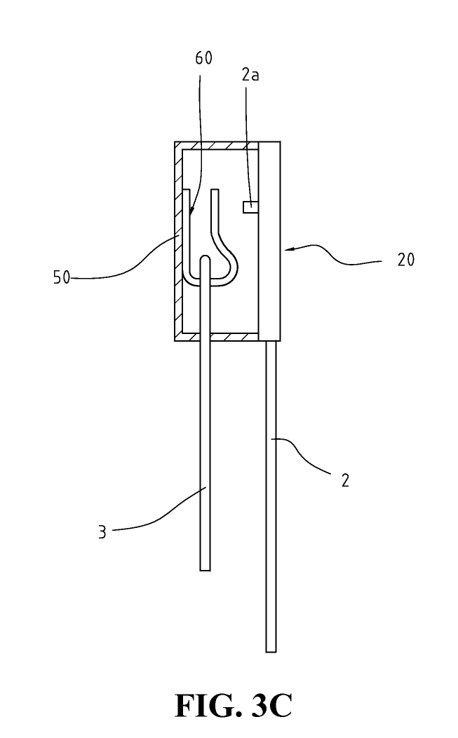

FIGS. 3A˜3C show a surge varistor according to another embodiment of the present invention. As illustrated, the disengagement member 30 also is an electrically and thermally conducting thin plate 60 coupled to the terminal 3 of the surge varistor. The plate 60 has a base portion 60a and a folded portion 60b folded towards the base portion 60a. A through opening 60c is provided within the folded portion 60b whose aperture allows the contact block 2a to pass through. The base portion 60a is flatly adhered to an inner surface of a hollow cover member 50. The cover member 50 attaches to the body of the varistor member 20, housing the plate 60 completely inside and exposing only the terminal 3. As illustrated in FIG. 3B, the folded portion 60b and the contact block 2a exposing through the through opening 60c are soldered together by the material 40. As such, an electrical connection is established from the terminal 2 to the terminal 3 via the plate 60 (i.e., the disengagement member 30). Without the binding of the material 40, as shown in FIG. 3C, the elasticity of the folded portion 60b would break away from the contact block 2a, thereby disrupting the electrical connection between terminals 2 and 3.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A surge varistor having a first terminal, a second terminal, and a third terminal, said surge varistor comprising:
a varistor member having a body and two terminals, said body being coated with electrically insulating material, said two terminals functioning as said first and said second terminals, an electrically and thermally conducting contact block being extended from an end of said second terminal buried inside said body for an appropriate distance out of said body; and
a disengagement member being an electrically and thermally conducting thin plate electrically connected to said third terminal, said thin plate having a base portion and an elastically folded portion, said folded portion being extended against its elasticity to adhere to said contact block, thereby establishing an electrical connection between said third and said second terminals;
wherein said second and said first terminals being parallel-connected to a load and said third and said second terminals being series-connected said load; when a surge occurs to said load, a large amount of current is shunt from said load via said third terminal, said thin plate of said disengagement member, and said varistor member; and, when the temperature of said surge varistor rises above a threshold, the adhesion of said contact block and said folded portion is destroyed and said folded portion breaks away from said contact block, thereby disrupting the electrical connection between said third and second terminals.

2. The surge varistor according to claim 1, wherein said base portion is adhered to said body of said varistor member without contacting said contact block.

3. The surge varistor according to claim 2, wherein said base portion has a through opening whose aperture is larger than the diameter of said contact block; and said base portion is adhered to said body of said varistor member with said contact block penetrating through said through opening and not contacting said base portion.

4. The surge varistor according to claim 1, further comprising a hollow cover member attached to said body of said varistor member, said cover member housing said thin plate completely inside and exposing only said third terminal.

5. The surge varistor according to claim 4, wherein said base portion is adhered to an inner surface of said cover member.

6. The surge varistor according to claim 1, wherein the adhesion of said folded portion to said contact block is by soldering an electrically and thermally conducting material; and the adhesion of said contact block and said folded portion is destroyed as said material is melted when the temperature of said surge varistor rises above said threshold.
